(19) United States
(12) Patent Application Publication
(10) Pub. No.: US 2024/0411663 A1
(43) Pub. Date: Dec. 12, 2024

(54) LATENT REPRESENTATION BASED APPEARANCE MODIFICATION FOR ADVERSARIAL TESTING AND TRAINING

(71) Applicant: WAABI Innovation Inc., Toronto (CA)

(72) Inventors: Jay SARVA, Fremont, CA (US); Jingkang WANG, Toronto (CA); James TU, Toronto (CA); Yuwen XIONG, Toronto (CA); Sivabalan MANIVASAGAM, Toronto (CA); Raquel URTASUN, Toronto (CA)

(73) Assignee: WAABI Innovation Inc., Toronto, ON (CA)

(21) Appl. No.: 18/736,126

(22) Filed: Jun. 6, 2024

Related U.S. Application Data
(60) Provisional application No. 63/471,950, filed on Jun. 8, 2023.

(51) Int. Cl. G06F 11/34; G06T 17/00

(52) U.S. Cl. CPC G06F 11/3457; G06T 17/00

(57) ABSTRACT

Latent representation based appearance modification for adversarial testing and training include obtaining a first latent representation of an actor, performing a modification of the first latent representation of an actor to obtain a second latent representation, and generating a 3D model from the second latent representation. The operations further include performing, by a simulator interacting with the virtual driver, a simulation of the virtual world having the 3D model of the actor and the autonomous system moving in the virtual world, evaluating the virtual driver interacting in the virtual world during the simulation to obtain an evaluation result, and outputting the evaluation result.

### CROSS-REFERENCE TO RELATED APPLICATIONS

This application is a non-provisional application of, and thereby claims benefit under 35 U.S.C. § 119 (e) to U.S. Patent Application Ser. No. 63/471,950 filed on Jun. 8, 2023, which is incorporated herein by reference in its entirety.

### BACKGROUND

A virtual world is a computer-simulated environment, which enables a player to interact in a three-dimensional space as if the player were in the real world. In some cases, the virtual world is designed to replicate at least some aspects of the real world. For example, the virtual world may include objects and background reconstructed from the real world. The reconstructing of objects and background from the real world allows the system to replicate aspects of the real world.

One reason for the replication is in the testing and training of a virtual driver of an autonomous system. The virtual driver should move safely in the real world. However, simple replay of movements of physical systems through the real world often does not capture the various conditions that the virtual driver may encounter. Thus, a problem exists in creating realistic scenarios that capture the real world in a virtual world.

### SUMMARY

In general, in one aspect, one or more embodiments relate to a computer-implemented method. The computer-implemented method includes obtaining a first latent representation of an actor, generating a first three-dimensional (3D) model from the first latent representation, performing, by a simulator interacting with a virtual driver of an autonomous system, a first simulation of a virtual world having the first 3D model of the actor and the autonomous system moving in the virtual world, and evaluating, using an adversarial objective function, the virtual driver interacting in the virtual world during the first simulation to obtain a first evaluation result. The method further includes performing a modification, according to the first evaluation result, the first latent representation of the actor to obtain a second latent representation, generating a second 3D model from the second latent representation, performing, by the simulator interacting with the virtual driver, a second simulation of the virtual world having the second 3D model of the actor and the autonomous system moving in the virtual world, evaluating the virtual driver interacting in the virtual world during the second simulation to obtain a second evaluation result, and outputting the second evaluation result.

In general, in one aspect, one or more embodiments relate to a system that includes memory and a computer processor that includes computer readable program code for performing operations. The operations include obtaining a first latent representation of an actor, generating a first three-dimensional (3D) model from the first latent representation, performing, by a simulator interacting with a virtual driver of an autonomous system, a first simulation of a virtual world having the first 3D model of the actor and the autonomous system moving in the virtual world, and evaluating, using an adversarial objective function, the virtual driver interacting in the virtual world during the first simulation to obtain a first evaluation result. The operations further include performing a modification, according to the first evaluation result, the first latent representation of the actor to obtain a second latent representation, generating a second 3D model from the second latent representation, performing, by the simulator interacting with the virtual driver, a second simulation of the virtual world having the second 3D model of the actor and the autonomous system moving in the virtual world, evaluating the virtual driver interacting in the virtual world during the second simulation to obtain a second evaluation result, and outputting the second evaluation result.

In general, in one aspect, one or more embodiments relate to a non-transitory computer readable medium that includes computer readable program code for performing operations. The operations include obtaining a first latent representation of an actor, generating a first three-dimensional (3D) model from the first latent representation, performing, by a simulator interacting with a virtual driver of an autonomous system, a first simulation of a virtual world having the first 3D model of the actor and the autonomous system moving in the virtual world, and evaluating, using an adversarial objective function, the virtual driver interacting in the virtual world during the first simulation to obtain a first evaluation result. The operations further include performing a modification, according to the first evaluation result, the first latent representation of the actor to obtain a second latent representation, generating a second 3D model from the second latent representation, performing, by the simulator interacting with the virtual driver, a second simulation of the virtual world having the second 3D model of the actor and the autonomous system moving in the virtual world, evaluating the virtual driver interacting in the virtual world during the second simulation to obtain a second evaluation result, and outputting the second evaluation result.

Other aspects of the invention will be apparent from the following description and the appended claims.

### BRIEF DESCRIPTION OF DRAWINGS

FIG. 1 shows a diagram of an autonomous training and testing system in accordance with one or more embodiments.

FIG. 2 shows a diagram of a portion of the simulator in accordance with one or more embodiments.

FIG. 3 shows a flowchart in accordance with one or more embodiments.

FIG. 4 shows a flowchart of the autonomous training and testing system in accordance with one or more embodiments.

FIG. 5A and FIG. 5B show examples in accordance with one or more embodiments.

FIG. 6A and FIG. 6B show a computing system in accordance with one or more embodiments of the invention.

Like elements in the various figures are denoted by like reference numerals for consistency.

### DETAILED DESCRIPTION

In general, embodiments are directed to modifying actor shapes in a realistic manner in order to train and/or test a virtual driver of an autonomous system. Specifically, a latent representation of an actor is obtained. The latent representation is a learned mathematical representation of the actor. In one or more embodiments, the latent representation is guided by representations from multiple types of actors. The latent representation, or a modified version thereof, is used to generate a three-dimensional (3D) model of an actor, which is then used in a simulation with the virtual driver. The virtual driver is evaluated based on the simulation with an adversarial objective function. The goal of the adversarial objective function is to find shapes of the actor that cause the virtual driver to behave or detect the actor incorrectly. Based on an evaluation of the virtual driver during the simulation, the latent representation is modified. Because the latent representation is modified rather than the 3D model, more realistic modifications may be performed. Through iteratively modifying the latent representation, performing simulations, and evaluating the virtual driver based on the simulations, the system may predict the shapes of the actor that causes the virtual driver to detect or operate incorrectly may be identified. The virtual driver may then be updated based on the output, or deployed if the virtual driver passes the testing phase.

As discussed, the virtual driver is a driver of an autonomous system. An autonomous system is a self-driving mode of transportation that does not require a human pilot or human driver to move and react to the real-world environment. Rather, the autonomous system includes the virtual driver that is the decision-making portion of the autonomous system. The virtual driver is an artificial intelligence system that learns how to interact in the real world. The autonomous system may be completely autonomous or semi-autonomous. As a mode of transportation, the autonomous system is contained in a housing configured to move through a real-world environment. Examples of autonomous systems include self-driving vehicles (e.g., self-driving trucks and cars), drones, airplanes, robots, etc. The virtual driver is the software that makes decisions and causes the autonomous system to interact with the real-world including moving, signaling, and stopping or maintaining a current state.

The real-world environment is the portion of the real world through which the autonomous system, when trained, is designed to move. Thus, the real-world environment may include interactions with concrete and land, people, animals, other autonomous systems, human driven systems, construction, and other objects as the autonomous system moves from an origin to a destination.

In order to interact with the real-world environment, the autonomous system includes various types of sensors, such as LiDAR sensors, which are used to obtain measurements of the real-world environment, and cameras that capture images from the real-world environment. Virtual drivers of the autonomous system use the inputs from the system to perform perception, prediction, and planning tasks. The perception task is the task of the virtual driver to use the sensor input to identify actors in the environment. The prediction task is the task of the virtual driver to forecast the future motion of the actors, such as based on current and past identifications. The planning task is the task of the virtual driver to plan the movement of the autonomous system according to the perception and prediction. The virtual driver then outputs control signals to cause the autonomous system to start implementing the plan. As more sensor input is received, the plan may be revised accordingly. In other words, the autonomous system may implement the start of the plan, which is revised over time as the environment changes and the autonomous system moves.

To deploy an autonomous system with a virtual driver safely, the virtual driver is trained and tested. The training and testing of the virtual driver may be performed by replaying logs capturing the real world and a non-autonomous system with sensors moving through the real world. Only replaying the real world to the virtual driver causes the virtual driver to only be exposed to a limited set of real-world scenarios. However, a goal of testing and training the virtual driver is to test and train a wide range of scenarios that cover the space of situations that the virtual driver might encounter in the real world to ensure the virtual driver can respond appropriately. Thus, the testing and training of the virtual driver may use synthetic scenarios that may be entirely synthetic or modified versions of real-world scenarios.

One part of the scenario is the shape of the actors in the environment. For example, the actor's shape may cause the autonomous system to incorrectly perform at least one of the perception, prediction, and planning tasks.

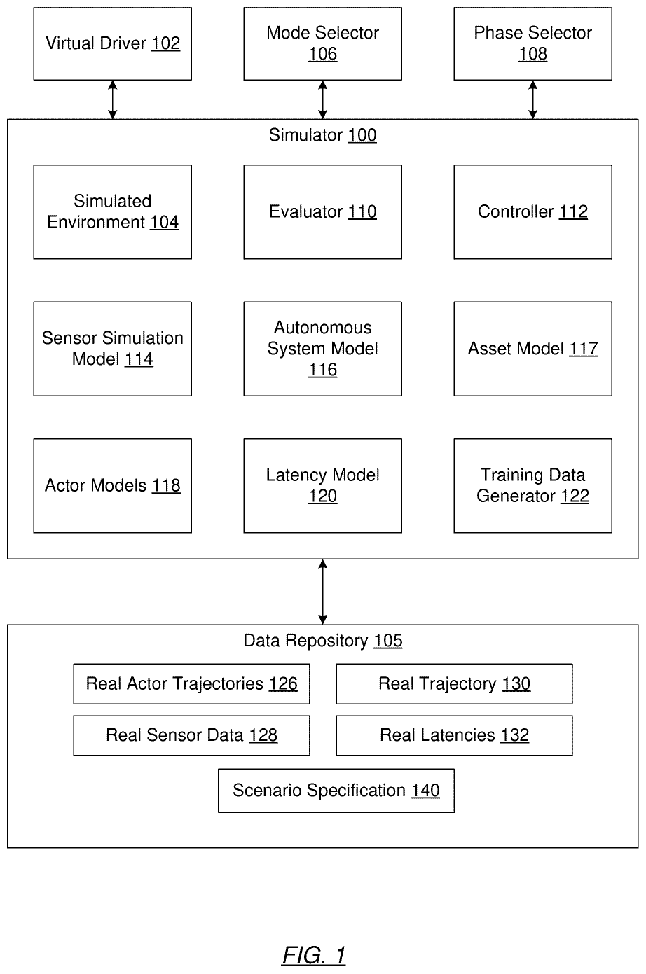

The testing and training of a virtual driver may be performed using the simulator (100) described in FIG. 1. As shown in FIG. 1, a simulator (100) is configured to train and test a virtual driver (102) of an autonomous system. For example, the simulator (100) may be a unified, modular, mixed reality, closed-loop simulator for autonomous systems. The simulator (100) is a configurable simulation framework that enables not only evaluation of different autonomy components in isolation, but also as a complete system in a closed-loop manner. The simulator reconstructs “digital twins” of real-world scenarios automatically, enabling accurate evaluation of the virtual driver at scale. The simulator (100) may also be configured to perform mixed-reality simulation that combines real world data and simulated data to create diverse and realistic evaluation variations to provide insight into the virtual driver's performance. The mixed reality closed-loop simulation allows the simulator (100) to analyze the virtual driver's (102) action on counterfactual “what-if” scenarios that did not occur in the real-world. The simulator (100) further includes functionality to simulate and train on rare yet safety-critical scenarios with respect to the entire autonomous system and closed-loop training to enable automatic and scalable improvement of autonomy.

The simulator (100) creates the simulated environment (104) which is a virtual world. The virtual driver (102) is the player in the virtual world. The simulated environment (104) is a simulation of a real-world environment, which may or may not be in actual existence, in which the autonomous system is designed to move. As such, the simulated environment (104) includes a simulation of the objects (i.e., simulated objects or assets) and background in the real world, including the natural objects, construction, buildings and roads, obstacles, as well as other autonomous and non-autonomous objects. The simulated environment (104) simulates the environmental conditions within which the autonomous system may be deployed. Additionally, the simulated environment (104) may be configured to simulate various weather conditions that may affect the inputs to the autonomous systems. The simulated objects may include both stationary and non-stationary objects. Non-stationary objects are actors in the real-world environment.

The simulator (100) also includes an evaluator (110). The evaluator (110) is configured to train and test the virtual driver (102) by creating various scenarios in the simulated environment (104). Each scenario is a configuration of the simulated environment (104) including, but not limited to, static portions, movement of simulated objects, actions of the simulated objects with each other, and reactions to actions taken by the autonomous system and simulated objects. The evaluator (110) is further configured to evaluate the performance of the virtual driver (102) using a variety of metrics.

The evaluator (110) assesses the performance of the virtual driver (102) throughout the performance of the scenario. Assessing the performance may include applying rules. For example, the rules may be that the automated system does not collide with any other actor, compliance with safety and comfort standards (e.g., passengers not experiencing more than a certain acceleration force within the vehicle), the automated system not deviating from executed trajectory, or other rule. Each rule may be associated with the metric information that relates a degree of breaking the rule with a corresponding score. The evaluator (110) may be implemented as a data-driven neural network that learns to distinguish between good and bad driving behavior. The various metrics of the evaluation system may be leveraged to determine whether the automated system satisfies the requirements of the success criterion for a particular scenario. Further, in addition to system level performance, for modular based virtual drivers, the evaluator (110) may also evaluate individual modules such as segmentation or prediction performance for actors in the scene with respect to the ground truth recorded in the simulator (100).

The simulator (100) is configured to operate in multiple phases as selected by the phase selector (108) and modes as selected by a mode selector (106). The phase selector (108) and mode selector (106) may be a graphical user interface or application programming interface component that is configured to receive a selection of phase and mode, respectively. The selected phase and mode define the configuration of the simulator (100). Namely, the selected phase and mode define which system components communicate and the operations of the system components.

The phase may be selected using a phase selector (108). The phase may be a training phase or a testing phase. In the training phase, the evaluator (110) provides metric information to the virtual driver (102), which uses the metric information to update the virtual driver (102). The evaluator (110) may further use the metric information to further train the virtual driver (102) by generating scenarios for the virtual driver (102). In the testing phase, the evaluator (110) does not provide the metric information to the virtual driver (102). The evaluator (110) in the testing phase uses the metric information to assess the virtual driver (102) and to develop scenarios for the virtual driver (102).

The mode may be selected by the mode selector (106). The mode defines the degree to which real-world data is used, whether noise is injected into simulated data, the degree of perturbations of real-world data, and whether the scenarios are designed to be adversarial. Example modes include open-loop simulation mode, closed-loop simulation mode, single module closed-loop simulation mode, fuzzy mode, and adversarial mode. In an open-loop simulation mode, the virtual driver is evaluated with real-world data. In a single module closed-loop simulation mode, a single module of the virtual driver is tested. An example of a single module closed-loop simulation mode is a localizer closed-loop simulation mode in which the simulator evaluates how the localizer estimated pose drifts over time as the scenario progresses in simulation. In a training data simulation mode, the simulator is used to generate training data. In a closed-loop evaluation mode, the virtual driver and simulation system are executed together to evaluate system performance. In the adversarial mode, the actors are modified to perform adversarial to the virtual driver. The goal of the adversarial mode is to identify and cause the virtual driver to perform tasks incorrectly. In the fuzzy mode, noise is injected into the scenario (e.g., to replicate signal processing noise and other types of noise). Other modes may exist without departing from the scope of the system.

The simulator (100) includes the controller (112) which includes functionality to configure the various components of the simulator (100) according to the selected mode and phase. Namely, the controller (112) may modify the configuration of each of the components of the simulator (100) based on the configuration parameters of the simulator (100). Such components include the evaluator (110), simulated environment (104), autonomous system model (116), sensor simulation models (114), asset models (117), actor models (118), latency models (120), and a training data generator (122).

The autonomous system model (116) is a detailed model of the autonomous system in which the virtual driver (102) will execute. The autonomous system model (116) includes model, geometry, physical parameters (e.g., mass distribution, points of significance), engine parameters, sensor locations and type, the firing pattern of the sensors, information about the hardware on which the virtual driver executes (e.g., processor power, amount of memory, and other hardware information), and other information about the autonomous system. The various parameters of the autonomous system model may be configurable by the user or another system.

For example, if the autonomous system is a motor vehicle, the modeling and dynamics may include the type of vehicle (e.g., car, truck), make and model, geometry, physical parameters such as the mass distribution, axle positions, type and performance of the engine, etc. The vehicle model may also include information about the sensors on the vehicle (e.g., camera, LiDAR, etc.), the sensors' relative firing synchronization pattern, and the sensors' calibrated extrinsics (e.g., position and orientation) and intrinsics (e.g., focal length). The vehicle model also defines the onboard computer hardware, sensor drivers, controllers, and the autonomy software release under test.

The autonomous system model (116) includes an autonomous system dynamic model. The autonomous system dynamic model is used for dynamics simulation that takes the actuation actions of the virtual driver (e.g., steering angle, desired acceleration) and enacts the actuation actions on the autonomous system in the simulated environment (104) to update the simulated environment (104) and the state of the autonomous system. To update the state, a kinematic motion model may be used, or a dynamics motion model that accounts for the forces applied to the vehicle may be used to determine the state. Within the simulator, with access to real log scenarios with ground truth actuations and vehicle states at each timestep, embodiments may also optimize analytical vehicle model parameters or learn parameters of a neural network that infers the new state of the autonomous system given the virtual driver outputs.

In one or more embodiments, the sensor simulation model (114) models, in the simulated environment, active and passive sensor inputs. Passive sensor inputs capture the visual appearance of the simulated environment (104) including stationary and nonstationary simulated objects from the perspective of one or more cameras based on the simulated position of the camera(s) within the simulated environment (104). Examples of passive sensor inputs include inertial measurement unit (IMU) and thermal. Active sensor inputs are inputs to the virtual driver of the autonomous system from the active sensors, such as LiDAR, RADAR, global positioning system (GPS), ultrasound, etc. Namely, the active sensor inputs include the measurements taken by the sensors, and the measurements being simulated based on the simulated environment based on the simulated position of the sensor(s) within the simulated environment. By way of an example, the active sensor measurements may be measurements that a LiDAR sensor would make of the simulated environment over time and in relation to the movement of the autonomous system.

In one or more embodiments, the sensor simulation model uses the locations and respective appearance models (e.g., three-dimensional (3D) models) of agents, assets, background, and other parts of the scene to render a scene. The scene is a snapshot of the virtual world at a particular moment in time. For example, the scene may be for a particular simulation timestep.

The sensor simulation model (114) is configured to simulate the sensor observations of the surrounding scene in the simulated environment (104) at each timestep according to the sensor configuration on the vehicle platform. When the simulated environment directly represents the real-world environment, without modification, the sensor output may be directly fed into the virtual driver (102). For light-based sensors, the sensor model simulates light as rays that interact with objects in the scene to generate the sensor data. Depending on the asset representation (e.g., of stationary and nonstationary objects), embodiments may use graphics-based rendering for assets with textured meshes, neural rendering, or a combination of multiple rendering schemes. Leveraging multiple rendering schemes enables customizable world building with improved realism. Because assets are compositional in 3D and support a standard interface of render commands, different asset representations may be composed in a seamless manner to generate the final sensor data. Additionally, for scenarios that replay what happened in the real world and use the same autonomous system as in the real world, the original sensor observations may be replayed at each timestep.

Asset models (117) include multiple models, each model modeling a particular type of individual asset in the real world. The assets may include inanimate objects such as construction barriers or traffic signs, parked cars, and background (e.g., vegetation or sky). Each of the entities in a scenario may correspond to an individual asset. As such, an asset model (117), or instance of a type of asset model (117), may exist for each of the objects or assets in the scenario. The assets can be composed together to form the three-dimensional simulated environment. An asset model (117) provides all the information needed by the simulator to simulate the asset. The asset model (117) provides the information used by the simulator (100) to represent and simulate the asset in the simulated environment (104).

The set of asset models (117) may include actor models (118), which are closely related to asset models. An actor model (118) represents an actor in a scenario. An actor is a sentient being that has an independent decision-making process. Namely, in the real world, the actor may be an animate being (e.g., a person or animal) that makes a decision based on an environment or may be another autonomous system. The actor makes active movement rather than or in addition to passive movement. An actor model (118), or an instance of an actor model (118) may exist for each actor in a scenario. The actor model (118) is a model of the actor. If the actor is in a mode of transportation, then the actor model (118) includes the model of transportation mode in which the actor is located. For example, actor models may represent pedestrians, children, vehicles being driven by drivers, pets, bicycles, and other types of actors.

The actor model (118) leverages the scenario specification and assets to control all actors in the scene and the actor's actions at each timestep. The actor's behavior is modeled in a region of interest centered around the autonomous system. Depending on the scenario specification, the actor simulation controls the actors in the simulation to achieve the desired behavior. Actors can be controlled in various ways. One option is to leverage heuristic actor models, such as an intelligent-driver model (IDM) that try to maintain a certain relative distance or time-to-collision (TTC) from a lead actor or heuristic-derived lane-change actor model. Another is to directly replay actor trajectories from a real log or to control the actor(s) with a data-driven traffic model. Through the configurable design, embodiments may mix and match different subsets of actors to be controlled by different behavior models. For example, far-away actors that initially may not interact with the autonomous system and can follow a real log trajectory, but when near the vicinity of the autonomous system may switch to a data-driven actor model. In another example, actors may be controlled by a heuristic or data-driven actor model that still conforms to the high-level route in a real-log. This mixed-reality simulation provides control and realism.

Further, actor models may be configured to be in cooperative or adversarial mode. In cooperative mode, the actor model models actors to act rationally in response to the state of the simulated environment. In adversarial mode, the actor model may model actors acting irrationally, such as exhibiting road rage and bad driving.

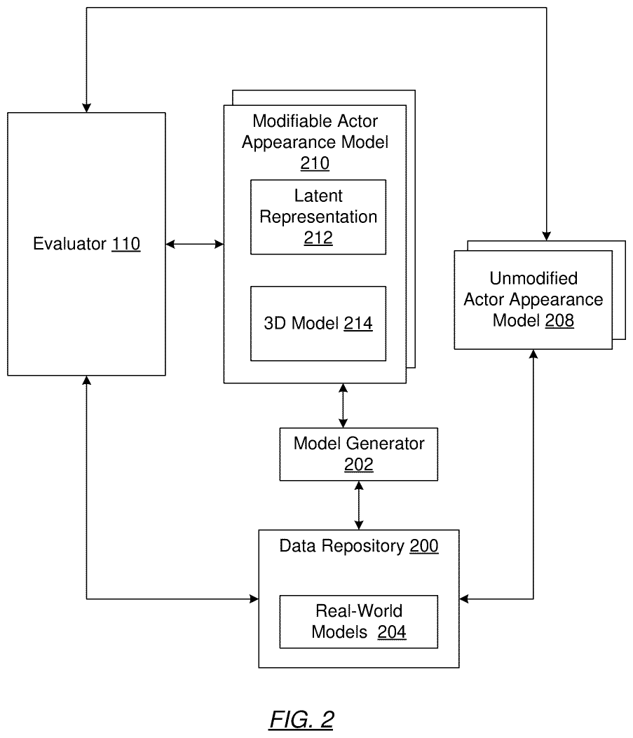

In one or more embodiments, the actor models (118) include the actor operation models and the actor appearance models. The actor operation models are models of the operations, trajectories, and positioning of actors. The actor appearance model is a model of the appearance of the actors. The appearance includes the shape and other visual characteristics. The actor operation model may or may not be influenced by the actor appearance model. For example, the simulator (100) may modify the shape of the actor in the actor appearance model, which is used by the actor operation model to determine a distance to various other objects in the virtual world. The actor appearance model is further described in FIG. 2 below.

The latency model (120) represents timing latency that occurs when the autonomous system is in a real-world environment. Several sources of timing latency may exist. For example, a latency may exist from the time that an event occurs to the sensors detecting the sensor information from the event and sending the sensor information to the virtual driver. Another latency may exist based on the difference between the computing hardware executing the virtual driver in the simulated environment as compared to the computing hardware of the virtual driver. Further, another timing latency may exist between the time that the virtual driver transmits an actuation signal to the autonomous system changing (e.g., direction or speed) based on the actuation signal. The latency model (120) models the various sources of timing latency.

Stated another way, safety-critical decisions in the real world may involve fractions of a second affecting response time. The latency model (120) simulates the exact timings and latency of different components of the onboard system. To enable scalable evaluation without strict requirements on exact hardware, the latencies and timings of the different components of the autonomous system and sensor modules are modeled while running on different computer hardware. The latency model (120) may replay latencies recorded from previously collected real-world data or have a data-driven neural network that infers latencies at each timestep to match the hardware in a loop simulation setup.

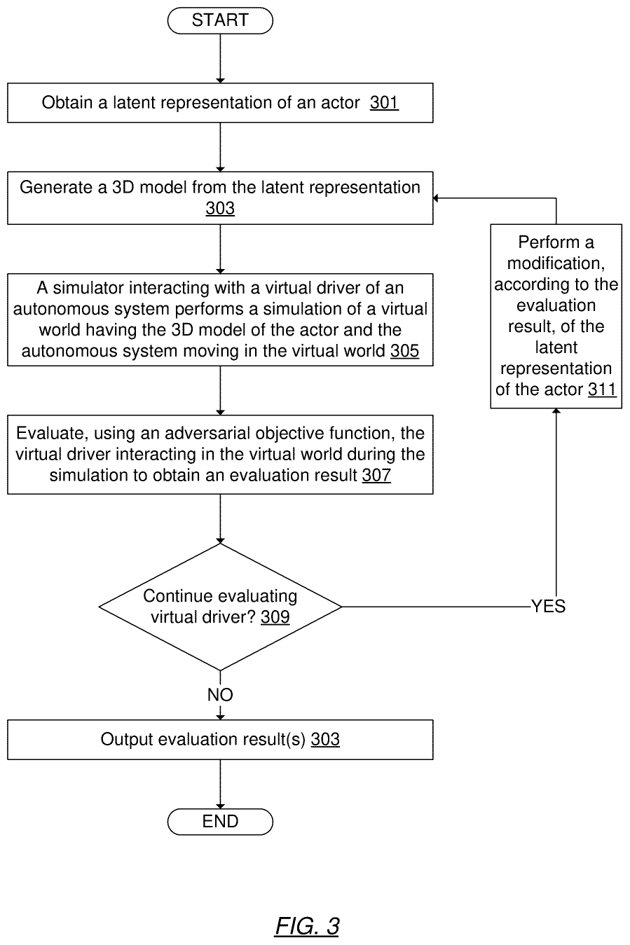

The training data generator (122) is configured to generate training data. For example, the training data generator (122) may modify real-world scenarios to create new scenarios. The modification of real-world scenarios is referred to as mixed reality. For example, mixed-reality simulation may involve adding in new actors with novel behaviors, changing the behavior of one or more of the actors from the real world, changing the appearance of the actors, and modifying the sensor data in that region while keeping the remainder of the sensor data the same as the original log. In some cases, the training data generator (122) converts a benign scenario into a safety-critical scenario. The training data generator (122) may be part of the evaluator (110). For example, the evaluator (110) with the training data generator (122) may perform the operations of FIG. 3.

The simulator (100) is connected to a data repository (105). The data repository (105) is any type of storage unit or device that is configured to store data. The data repository (105) includes data gathered from the real world. For example, the data gathered from the real world includes real actor trajectories (126), real sensor data (128), real trajectories of the system capturing the real world (130), and real latencies (132). Each of the real actor trajectories (126), real sensor data (128), real trajectory of the system capturing the real world (130), and real latencies (132) is data captured by or calculated directly from one or more sensors from the real world (e.g., in a real-world log). In other words, the data gathered from the real-world are actual events that happened in real life. For example, in the case that the autonomous system is a vehicle, the real-world data may be captured by a vehicle driving in the real world with sensor equipment.

Further, the data repository (105) includes functionality to store one or more scenario specifications (140). A scenario specification (140) specifies a scenario and evaluation setting for testing or training the autonomous system. For example, the scenario specification (140) may describe the initial state of the scene, such as the current state of the autonomous system (e.g., the full 6D pose, velocity and acceleration), the map information specifying the road layout, and the scene layout specifying the initial state of all the dynamic actors and objects in the scenario. The scenario specification may also include dynamic actor information describing how the dynamic actors in the scenario should evolve over time which are inputs to the actor models. The dynamic actor information may include route information for the actors, desired behaviors or aggressiveness. The scenario specification (140) may be specified by a user, programmatically generated using a domain-specification language (DSL), procedurally generated with heuristics from a data-driven algorithm, or adversarial-based generation. The scenario specification (140) can also be conditioned on data collected from a real-world log, such as taking place on a specific real-world map or having a subset of actors defined by their original locations and trajectories.

The interfaces between the virtual driver (102) and the simulator (100) match the interfaces between the virtual driver (102) and the autonomous system in the real world. For example, the sensor simulation model (114) and the virtual driver (102) match the virtual driver (102) interacting with the sensors in the real world. The virtual driver (102) is the actual autonomy software that executes on the autonomous system. The simulated sensor data that is output by the sensor simulation model (114) may be in or converted to the exact message format that the virtual driver takes as input as if the virtual driver were in the real world, and the virtual driver can then run as a black box virtual driver with the simulated latencies incorporated for components that run sequentially. The virtual driver (102) then outputs the exact same control representation that it uses to interface with the low-level controller on the real autonomous system. The autonomous system model (116) will then update the state of the autonomous system in the simulated environment (104). Thus, the various simulation models of the simulator (100) run in parallel asynchronously at their own frequencies to match the real-world setting.

In one or more embodiments, the virtual driver (102) may be configured to output intermediate results. Intermediate results are results that are generated prior to transmission of control signals. For example, the intermediate results may include detected bounding boxes around detected actors, predicted occupancy of voxels, predicted trajectories of actors, and motion planning.

FIG. 2 shows a diagram of a portion of the simulator in accordance with one or more embodiments. The data repository (200) may be the same or similar to the data repository (105) of FIG. 1. For example, the data repository (200) may be a third-party data repository. The data repository (200) includes functionality to store real-world models (204).

Real-world models (204) are 3D appearance models of actual actors or types of actors that actually exist in the real world. The 3D models replicate the appearance of a corresponding actor or an actor of a particular type. For example, a real-world model may be accurate (i.e., within an engineering tolerance) 3D representation of a particular make, model, and year of a vehicle type or other mode of transportation. As another example, the real-world model may be an object reconstruction of a particular vehicle, including dents and scratches, such as by using sensor data. The real-world models (204) may be computer-aided-design (CAD) models, such as from a public CAD library. For example, the real-world models (204) may include one or more of surface models, wireframe models, solid models, or other types of models.

The real-world models (204) may be used directly for some actors, as an unmodified actor appearance model (208) for the actors. In the unmodified actor appearance models (208), the real-world models (204) are used exactly or only transformed into a data format that the simulator can use. For example, if the real-world models (204) are wireframe models, the actor appearance model may be a surface model, set of marching cubes, or other type of model that is a data transformation of the corresponding real-world model (204).

One or more other actor appearance models may be set as a modifiable actor appearance model (210). A modifiable actor appearance model (210) is an actor appearance model that may have the appearance modified by the evaluator (110). The modifiable actor appearance model (210) includes a latent representation (212) and a 3D model (214). The latent representation (212) is a vector space representation learned over a set of actors of various actor types. In one or more embodiments, the latent representation (212) is a representation determined by performing principal component analysis on multiple different types of actors. Thus, the latent representation (212) may be a compact representation of the actor. The latent representation (212) may be directly modified to modify the appearance of the actor. However, because the latent representation (212) is a learned representation of the actor, the modification may not be directly identified by a human into a corresponding shape.

The latent representation (212) may be transformed into a 3D model (214). The 3D model (214) is an appearance model of the actor and may be in the same format as the unmodified actor appearance model (208). The 3D model (214) may have appearance values, such as color, luminance, opacity, etc., associated with locations on the 3D model (214). For example, the 3D model (214) is a model that is used by the sensor simulation model to render simulated sensor input (e.g., LiDAR or Camera input) for the virtual driver. By way of an example, the 3D model (214) may be a surface model, wireframe model, set of marching cubes, or other such 3D model (214) of the appearance of the actor.

The data repository (200) is connected to a model generator (202). The model generator (202) may be a component of the simulator (shown in FIG. 1), a component of the evaluator (110), or a separate component. The model generator (202) is software configured to transform real-world models into a latent representation (212). Performing the transformation is described below with reference to FIG. 3.

The modifiable actor appearance model (210), data repository (200), and unmodified actor appearance model (208) is connected to an evaluator (110). The evaluator (110) is the same or similar to the evaluator described in reference to FIG. 1. The evaluator (110) is software that includes functionality to modify the latent representation (212) and generate the 3D model (214). The evaluator (110) further includes functionality to define a scenario, trigger the execution of a simulation of the scenario, and obtain output from the virtual driver and the simulation. The evaluator (110) additionally includes functionality to evaluate the virtual driver based on the execution and perform additional evaluations. In one or more embodiments, the evaluator (110) includes functionality to execute adversarial to the virtual driver.

In one or more embodiments, a loss function processed by the evaluator (110) is not to train the virtual driver, but rather to identify modifications to actors that cause the virtual driver to perform incorrectly. Namely, when used to train the virtual driver, a loss function decreases the loss when the virtual driver performs correctly and increases the loss when the virtual driver performs incorrectly. The losses are then applied to one or more components of the virtual driver. Namely, when used to test the virtual driver, a loss function increases the loss when the virtual driver performs correctly and decreases the loss when the virtual driver performs incorrectly. The losses are then applied to performing further modifications of the latent representation. The processing performed by the evaluator and the model generator is presented in FIG. 3.

FIG. 3 shows a flowchart in accordance with one or more embodiments.

Although blocks of the flowcharts are shown sequentially, the blocks may be performed in virtually any order. Further, some blocks may be actively performed while other blocks are passively performed, such as performed when a triggering condition exists. Further, one or more of the blocks may be omitted.

In Block 301, a latent representation of an actor is obtained. In one or more embodiments, real-world models of various actors are obtained. For example, the real-world models may be obtained from a library or another machine learning model.

Different mechanisms may be used to generate the latent representation. In one or more embodiments, a dense representation of the real-world model is obtained. The dense representation may be the real-world model or a mathematical transformation of the real-world model. The process of generating the dense representation is repeated for each of at least a subset of the real-world models. Analyzing multiple dense representations, principal component analysis is performed. For a particular actor, the result of the principal component analysis may be applied to the particular actor's dense representation to generate a sparse representation for the particular actor. For example, the principal component analysis may be a set of principal components and a mean for the set of principal components. The dense representation of the actor may be reduced to remove values not corresponding to the set of principal components. Further, the mean may be used to adjust the remaining values and result in a sparse representation. The sparse representation may be the latent representation.

In some embodiments, the principal component analysis is performed across actors of various types of a mode of transportation. For example, if the mode of transportation is vehicles, the principal component analysis may be performed on dense representations across multiple different types of vehicles (e.g., sedans, sport utility vehicles, trucks, vans, etc.) while a separate principal component analysis is performed for pedestrians of different types. In other embodiments, principal component analysis may partition a mode of transportation into possibly overlapping subtypes. For example, class A, class B, and class C vehicles may be in different groups and principal component analysis may be performed individually for each class. Then, for a particular actor, the corresponding result of the principal component analysis of the class or group of the actor is applied to the particular actor's dense representation.

The following is an example mechanism for generating a latent representation. In the example mechanism, signed distance fields may be used. In such embodiments, individually for each real-world model, a signed distance field is obtained. The signed distance field is a mathematical model that describes the distance between any point in space and the nearest point on a surface of the actor. The distance is positive if the point in space is outside the surface of the actor, negative if the point in space is inside the actor, and zero if the point in space is on the surface of the actor. The signed distance field may be truncated by eliminating points in space that have greater than a threshold signed distance value (e.g., farther away than the threshold to the surface). Further, the signed distance field may be volumetric with each point having the signed distance field value located at a corresponding 3D location. For example, each location in a 3D volume that is equal or less than a distance to the surface has a corresponding signed distance value. The process may be repeated individually for each of the real-world models to obtain multiple signed distance fields.

The dense representations (e.g., volumetric truncated signed distance fields) may be flattened. For example, values with locations in the 3D vector may be stored into a corresponding location in a one-dimensional (1D) vector. The flattening may be performed for each of the dense representations. Over the multiple flattened dense representations, principal component analysis is performed to obtain the set of principal components and the mean. The set of principal components and the mean are applied to an actor's flattened dense representation to obtain the actor's latent representation. The process may be repeated for each of the multiple dense representations to obtain multiple latent representations, each latent representation corresponding to an actor type or a particular actor. Further, constraint values may be determined for the latent representations. For example, the constraint values may be a minimum and maximum value. For example, with each location, a minimum value at the location amongst the latent representations may be determined and used as a minimum constraint value. Similarly, with each location, a maximum value at the location amongst the latent representations may be determined and used as the maximum constraint value for the location. The process may be repeated for each location in a latent representation. Other constraint values, such as average, difference from neighbor, or other value may additionally or alternatively be used.

In Block 303, a 3D model from the latent representation is generated. For example, a marching cubes representation may be generated from the latent representation. Each value in the latent representation corresponds to location in a dense representation that may or may not be modified. Further, each value may have a corresponding location in 3D space defined by the location of the value within the latent representation. Thus, generating the 3D model may be a mathematical transformation based on the type of latent representation and the type of 3D model. One type of 3D representation is a set of marching cubes that may be generated from the latent representations. Marching cubes create a surface representation from voxel data.

In Block 305, a simulator interacting with a virtual driver of an autonomous system performs a simulation of a virtual world having the 3D model of the actor and the autonomous system moving in the virtual world. The initial state of the simulated environment is the state defined by the evaluator. In some embodiments, the evaluator may have a mixed reality simulation. In the mixed reality simulation, log data from the real world is used to generate an initial virtual world. The log data defines which asset and actor models are used in the initial positioning of assets. For example, using convolutional neural networks on the log data, the various asset types within the real world may be identified. As other examples, offline perception systems and human annotations of log data may be used to identify asset types. Accordingly, corresponding asset and actor models may be identified based on the asset types. The corresponding asset and actor models may be added to respective positions of the real actors and assets in the real world. Thus, the asset and actor models create an initial three-dimensional virtual world. One or more of the actors may be modified by changing the behavior of the actor, changing the initial location of the actor, and changing the appearance of the actor as described below. For example, the behavior may be changed to specify that the actor is aggressive or not aggressive, a speed, stopping distance that the actor allows, or other modification.

In one or more embodiments, the simulation is a closed-loop simulation. In the closed-loop simulation, the simulation is performed over several timesteps (e.g., more than just five or ten timesteps) as the virtual driver and the actors react to each other according to respective programming, configurations, and machine learning models. The virtual driver and the actors may have a respective goal location that may be many timesteps after the simulation is complete. The goal location may help define the trajectory of the virtual driver and actor by being one of the inputs. For example, a closed-loop simulation may have a twenty-second time horizon. By having a longer time horizon, the accuracy of the prediction and the accuracy of the planning may be determined. Namely, the simulation plays out to determine whether the virtual driver had an accurate prediction of where the actor would travel and make a plan that satisfies predefined evaluation metrics. In a short simulation that is open-loop simulations, frame-based simulation is performed and the simulation does not have actors react. Thus, the plan of the autonomous system is not executed.

In Block 307, using an adversarial objective function, the virtual driver interacting in the virtual world during the simulation is evaluated to obtain an evaluation result. In one or more embodiments, the adversarial objective function calculates a loss that is determined over several timesteps. The adversarial objective function may calculate a cost that is a sum of a set of losses. The set of losses may include a perception loss (i.e., a detection loss), a prediction loss, and a planning loss.

The perception loss may be calculated by identifying a loss due to true positive detections and a loss due to false positive detections. The manner of calculating perception loss may be dependent on whether the virtual driver performs bounding box detection or voxel occupancy detection. In bounding box detection, the virtual driver attempts to explicitly detect each actor and define a bounding box around the detected actor. The bounding box that the virtual driver detects is a detected bounding box. For each of multiple timesteps of the simulation, the virtual driver may output, as intermediate output, the detected bounding box around each detected actor. Thus, the evaluator receives a set of detected bounding boxes detected by the virtual driver and each corresponding to a timestep. The evaluator compares the set of detected bounding boxes to the set of actual bounding boxes that are actually in the simulation to generate a detection loss. The detection loss is increased when the detected bounding box matches the actual bounding box (e.g., a true positive detection is performed). The detection loss is decreased when the detected bounding box is a false detected bounding box. A false detected bounding box is a bounding box detected by the virtual driver for a hallucinated actor (i.e., one that does not actually exist because the detected bounding box is not in the set of actual bounding boxes).

A similar technique may be performed if the virtual driver performs occupancy-based detection. In occupancy-based detection, the virtual driver does not identify an actor. Rather, the virtual driver determines, for various locations in the virtual world along the virtual driver's trajectory, whether the location is occupied. Each location in the virtual world is mapped to a voxel that has a location in 3D space. Namely, the virtual world is partitioned into a 3D grid, whereby each grid cell is a voxel. The virtual driver then executes a machine learning model to determine whether, based on sensor data, a voxel queried by the virtual driver is occupied. Thus, for example, although the occupation may be by an actor, the virtual driver does not detect the actor. To obtain a detection loss based on occupancy-based detection, the comparison is performed at the voxel level. Specifically, the predicted occupancy of a set of voxels by the virtual driver during each timestep is compared to the actual occupancy, as defined by the simulator, during each timestep. The detection loss is increased when the predicted occupancy matches the actual occupancy and decreased when the predicted occupancy does not match the actual occupancy.

For prediction loss based on the trajectory of the actors, the predicted trajectory of the actor by the virtual driver is received by the evaluator from the virtual driver. The predicted trajectory may be from intermediate output generated by the virtual driver. The evaluator then compares the predicted trajectory to the actual trajectory of each actor to determine the prediction loss. The prediction loss is increased when the predicted trajectory matches the actual trajectory.

At the occupancy level, if the actors are not explicitly detected, then at each timestep the virtual driver makes a prediction as to which voxels will be occupied in the future based on the voxels that are currently occupied (e.g., at the point level, if the point is occupying a current voxel, where will the point be at a defined number of timesteps in the future). Stated another way, the evaluator compares the predicted and actual trajectories of the voxels (i.e., the points within the voxels) over time. Similar to the actor level for prediction loss, the prediction loss is increased when the predicted trajectory matches the actual trajectory.

The evaluator may determine a planning loss based on an amount of jerk and lateral acceleration caused by the virtual driver during the simulation. For example, if the virtual driver caused the virtual autonomous system to stop or start quickly, the planning loss is decreased. If the virtual driver caused the virtual autonomous system to perform many lateral movements, such as to swerve around actors, the planning loss is decreased. Conversely, if the virtual driver drove the virtual autonomous system smoothly during the simulation, the planning loss is increased.

The various losses are combined to generate a cost value. The combination may be a weighted combination, whereby the weights are hyperparameters. The combined cost may indicate if the virtual driver passed the simulation (e.g., by comparison to a threshold) and the effect of modification.

In Block 309, a determination is made whether to continue evaluating the virtual driver. In one or more embodiments, the processing of FIG. 3 may be performed to perform coverage testing. Thus, through iteratively modifying latent representations of the actor (described below in Block 311), simulating the virtual world with the actor, and evaluating, embodiments execute a search algorithm on the cost to identify a set of actor shapes that the virtual driver incorrectly processes. For example, the search algorithm may be a statistical search algorithm that partitions a search space into pass and not pass. The search space is the number of different, yet realistic, modifications of each of the actors. The modifications in the search space may be appearance modifications by modifying the latent representation, behavior modifications, or other modifications. Further, a single actor may be modified, multiple actors may be modified, and the virtual driver may be modified.

If a determination is made to continue, the flow proceeds to Block 311 to modify one or more actors. If the determination is made not to continue or the determination is made to output evaluation results, the flow may proceed to Block 313. Although not shown in FIG. 3, after outputting evaluation results, further simulation may be performed continuing with Block 311.

In Block 311, a modification, according to the evaluation result, of the latent representation of the actor is performed. The amount of modification may be defined by the search algorithm and the result of the cost function. Rather than artificially modifying the 3D model, the latent representation that is generated using multiple dense representations of multiple actors (e.g., as described above) is modified. Further, the modification is performed according to the constraint values. For example, the modification may be performed so as to not exceed the maximum or minimum constraint values. If the latent representation is a signed distance field value, then the modification may change the location of the surface with respect to one or more points. By changing the location of the surface, the 3D appearance of the actor changes. Other modifications of the latent representation may be performed.

Although FIG. 3 describes obtaining the latent representation, performing the simulation, and then modifying the latent representation, in some embodiments, the latent representation obtained in Block 301 may be a modified using the operations of Block 311 prior to performing the initial simulation.

Continuing with FIG. 3, in Block 313, the evaluation result(s) may be outputted. The evaluator may output the evaluation result to a graphical user interface. For example, the evaluator may output a graph defining types of shapes that the virtual driver performed incorrectly. The outputting of the evaluation result(s) may be to a virtual driver training component that includes functionality to update the virtual driver. In such a scenario, the evaluation result may be used to generate a loss. The loss may be backpropagated through the virtual driver or a machine learning model of the virtual driver to update the virtual driver. The evaluation results may be divided into whether the virtual driver correctly perceived the actor, predicted the movement of the actor, and the trajectory of the virtual driver. By partitioning the evaluation results into the different tasks of the virtual driver, one or more embodiments may be able to identify the particular machine learning model(s) of the virtual driver that did not pass and update the machine learning models accordingly.

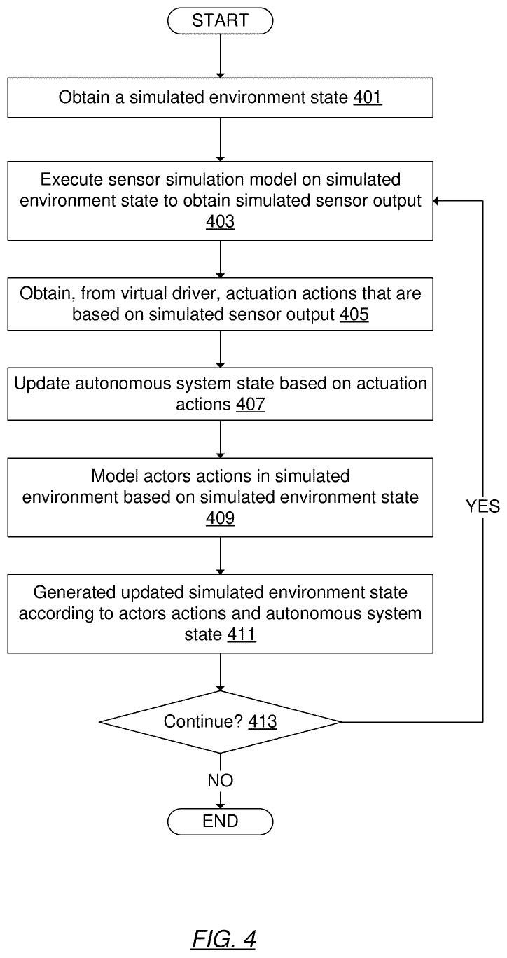

FIG. 4 shows a flow diagram for executing the simulator in a closed-loop mode. Specifically, FIG. 4 expands on Block 305 of FIG. 3 in one or more embodiments. In Block 401, a simulated environment state is obtained. The simulated environment state is the initial state of the 3D simulated environment according to the scenario that is defined by the evaluator in FIG. 3.

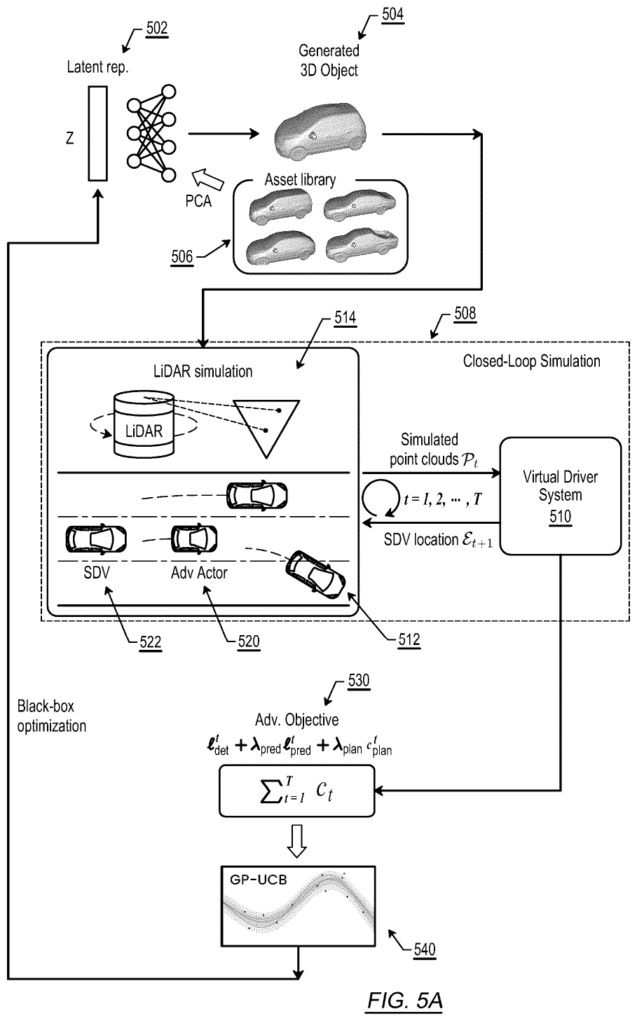

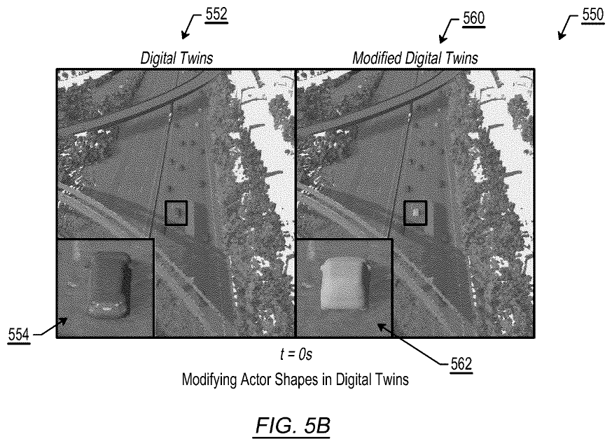

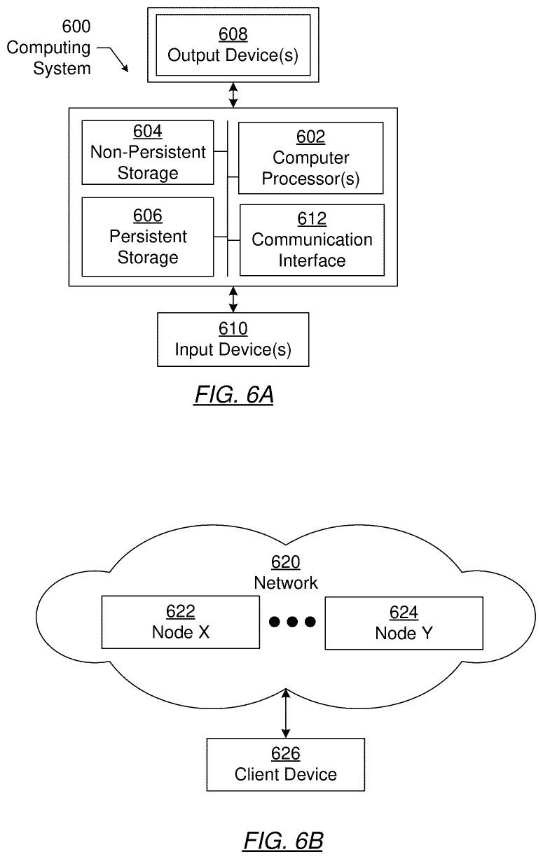

In Block 403, the sensor simulation model is executed on the simulated environment state to obtain simulated sensor output. The sensor simulation model may use beamforming and other techniques to replicate the view to the sensors of the autonomous system. Each sensor of the autonomous system has a corresponding sensor simulation model and a corresponding system. The sensor simulation model executes based on the position of the sensor within the virtual environment and generates simulated sensor output. The simulated sensor output is in the same form as would be received from a real sensor by the virtual driver. In one or more embodiments, Block 403 may be performed as shown in FIG. 5A and FIG. 6 (described below) to generate camera output for a virtual camera. The processing of FIG. 5A and FIG. 6 may be performed for each of the virtual cameras on the autonomous system. Some of the operations may be performed once and the data generated reused for the different cameras or even for different scenarios. For example, the same generated source light representation may be used for generating augmented images for multiple cameras without regenerating the source light representation and for generating multiple different lighting scenarios. Similarly, the same selection of a target light representation may be used for multiple cameras. The operations of FIG. 5A and FIG. 6 may be performed for each camera and LiDAR sensor on the autonomous system to simulate the output of the corresponding camera and LiDAR sensor. Location and viewing direction of the sensor with respect to the autonomous vehicle may be used to replicate the originating location of the corresponding virtual sensor on the simulated autonomous system. Thus, the various sensor inputs to the virtual driver match the combination of inputs if the virtual driver were in the real world.

The simulated sensor output is passed to the virtual driver. In Block 405, the virtual drive executes based on the simulated sensor output to generate actuation actions. The actuation actions define how the virtual driver controls the autonomous system. For example, for a self-driving vehicle, the actuation actions may be the amount of acceleration, movement of the steering, triggering of a turn signal, etc. From the actuation actions, the autonomous system state in the simulated environment is updated in Block 407. The actuation actions are used as input to the autonomous system model to determine the actual actions of the autonomous system. For example, the autonomous system dynamic model may use the actuation actions in addition to road and weather conditions to represent the resulting movement of the autonomous system. For example, in a wet or snowy environment, the same amount of acceleration action as in a dry environment may cause less acceleration than in the dry environment. As another example, the autonomous system model may account for possibly faulty tires (e.g., tire slippage), mechanical based latency, or other possible imperfections in the autonomous system.

In Block 409, actors' actions in the simulated environment are modeled based on the simulated environment state. Concurrently with the virtual driver model, the actor models and asset models are executed on the simulated environment state to determine an update for each of the assets and actors in the simulated environment. Here, the actors' actions may use the previous output of the evaluator to test the virtual driver. For example, if the actor is adversarial, the evaluator may indicate based on the previous action of the virtual driver, the lowest scoring metric of the virtual driver. Using a mapping of metrics to actions of the actor model, the actor model executes to exploit or test that particular metric.

Thus, in Block 411, the simulated environment state is updated according to the actors' actions and the autonomous system state to generate an updated simulated environment state. The updated simulated environment includes the change in positions of the actors and the autonomous system. Because the models execute independently of the real world, the update may reflect a deviation from the real world. Thus, the autonomous system is tested with new scenarios. In Block 413, a determination is made whether to continue. If the determination is made to continue, testing of the autonomous system continues using the updated simulated environment state in Block 403. At each iteration, during training, the evaluator provides feedback to the virtual driver. Thus, the parameters of the virtual driver are updated to improve the performance of the virtual driver in a variety of scenarios. During testing, the evaluator is able to test using a variety of scenarios and patterns including edge cases that may be safety critical. Thus, one or more embodiments improve the virtual driver and increase the safety of the virtual driver in the real world.

As shown, the virtual driver of the autonomous system acts based on the scenario and the current learned parameters of the virtual driver. The simulator obtains the actions of the autonomous system and provides a reaction in the simulated environment to the virtual driver of the autonomous system. The evaluator evaluates the performance of the virtual driver and creates scenarios based on the performance. The process may continue as the autonomous system operates in the simulated environment.

FIG. 5A shows an example in the case of a virtual driver being a virtual driver of a self-driving vehicle (SDV). Although an SDV environment is described, the techniques described below may be applied to other types of technologies.

Self-driving vehicles (SDVs) are rigorously tested on a wide range of scenarios to ensure safe deployment. Closed-loop simulation may be performed to evaluate how the SDV interacts on a corpus of synthetic and real scenarios and verify that the SDV performs properly. The example implementation takes real-world scenarios and performs closed-loop sensor simulation to evaluate the virtual driver's performance and finds vehicle shapes of actors that make the scenario more challenging, resulting in the virtual driver's failures and uncomfortable SDV maneuvers. The example implementation optimizes a low-dimensional shape representation to modify the vehicle shape itself in a realistic manner to degrade the virtual driver performance (e.g., perception, prediction, and motion planning). Moreover, the shape variations found optimized according to the example implementation in closed-loop simulation may be more effective than found in open-loop simulation.

To deploy SDVs safely, the example implementation tests the virtual driver system on a wide range of scenarios that cover the space of situations the virtual driver might see in the real world and ensure the virtual driver can respond appropriately. At least two strategies may be employed to increase scenario coverage including creating synthetic scenarios and retrieving real-world scenarios from a large collection of logs captured during real-world driving. Closed-loop simulation of the scenarios is performed to test the SDV in a reactive manner, so that the effects of the virtual driver's decisions are evaluated in a longer horizon. The use of closed-loop simulation is performed because small errors in planning can cause the SDV to brake hard or swerve. If coverage testing is restricted to the behavioral aspects of the system and only motion planning is evaluated, then the coverage testing does not consider scene appearance and ignores how perception and prediction mistakes might result in safety critical errors with catastrophic consequences, e.g., false positive detections or predictions might result in a hard break, while false negatives detections could cause collision.

The following describes LiDAR-based stack as LiDAR is often employed sensor in self-driving. The same operations may be applied to camera images or other sensor input. Naively sampling the possible variations is computationally intractable, as coverage should include the myriad of both behavioral scenarios and appearance variations, such as actor shape. Towards this goal, the example implementation performs searches over the worst possible actor shapes for each scenario, and attacks the full the virtual driver system, including perception, prediction, and motion planning.

The example implementation may use a high-fidelity LiDAR simulation system that builds modifiable digital twins of real-world driving snippets, enabling closed-loop sensor simulation of complex and realistic traffic scenarios at scale. Thus, when modifying the scene with a new actor shape, the virtual driver is tested to determine how the virtual driver would respond to the new sensor data as if the virtual driver were in the real world (e.g., braking hard, steering abruptly) as the scenario evolves. To ensure the generated actor shapes are realistic, during optimization, the shape of the actor is constrained to be within a low-dimensional latent space learned over a set of actual object shapes.

The example implementation conducts black-box adversarial attacks against the various machine learning models of the virtual driver to modify actor shapes in real-world scenarios to cause virtual driver failures. To efficiently find realistic actor shapes that harm performance, the example implementation parameterizes the actor's shape as a low-dimensional latent code and constrains the search space to lie within the bounds of actual vehicle shapes. Given a real-world driving scenario, the example implementation may select actors near the virtual driver and modifies actor's shapes with the generated shapes. The example implementation performs closed-loop sensor simulation to determine how the SDV interacts with the modified scenario over time and to measure performance. The adversarial objective includes perception, prediction, and planning losses to find errors in different parts of the virtual driver. Black-box optimization per scenario is performed to enable testing of any the virtual driver system at scale.

Turning specifically to FIG. 5A, closed-loop simulation (508) of a virtual driver system (e.g., the various components of the virtual driver) (510) may be defined as follows. A traffic scenario [symbol] ₜ at snapshot time t (512) may include a static background [symbol] and N actors: [symbol] ₜ={{ [symbol] ₜ¹, [symbol] ₜ², . . . , [symbol] ₜ^{N}}, [symbol] }. Each actor [symbol] ₜ consists of { [symbol] , ξₜ}, where [symbol] and ξₜ represent the actor's geometry and the actor's pose at time t. Given [symbol] ₜ and the SDV location εₜ, the simulator ψ generates sensor data (e.g., LiDAR simulation (514) in the example) according to the SDV's sensor configuration. The virtual driver system [symbol] (510) then consumes the sensor data, generates intermediate outputs [symbol] such as detections and the planned trajectory, and executes a driver command [symbol] (e.g., steering and acceleration) via the following mapping [symbol] : ψ( [symbol] , ε)→ [symbol] × [symbol] , The simulator then updates the SDV location given the driver command εₜ, [symbol] →εₜ₊₁ as well as updates the actor locations to generate the scenario snapshot [symbol] ₜ₊₁. This loop continues and embodiments can observe the virtual driver interacting with the scenario over time.

Given the above closed-loop formulation, actors in the scene may be selected to modify their shapes and optimize to identify the virtual driver's failures. For simplicity, the following describes a single modified actor, but the approach is general and multiple actors may be modified concurrently. Let [symbol] _{adv}ⁱ denote the safety-critical 3D object geometry for the interactive actor [symbol] ⁱ. A goal is to generate [symbol] _{adv}ⁱ that is challenging to the virtual driver system [symbol] . A cost function [symbol] ₜ that takes the current scene and the virtual driver outputs to determine the virtual driver performance at time t. The cost may be accumulated over time to measure the overall closed-loop performance, resulting in the following objective:

$$\\ \begin{matrix}{𝒢}_{adv}^{{}_{} i} = arg {max}_{{𝒢}^{{}_{} i}} {\sum }_{t = 1}^{T} {𝒞}_{t} ( {𝒮}_{t} , ℱ ( \tilde{ψ} ( {𝒮}_{t} , {𝒢}^{{}_{} i} , {ℰ}_{{}_{} t} ) ) ) , & ( 1 )\end{matrix}$$

where the sensor simulator \tilde{ψ} takes the original scenario [symbol] ₜ but replaces the geometry of actor [symbol] ⁱ with the optimized shape [symbol] ⁱ, and simulates new sensor data.

The following is a description of how the example implementation builds digital twins from real world scenarios to perform realistic closed-loop sensor simulation (via \tilde{ψ}) for the virtual driver testing. Then, the example implementation parameterization of the actor shape [symbol] ⁱ to enable realistic and efficient optimization is described.

In the example implementation, real-world LiDAR data and object annotations are leveraged to build aggregated meshes (e.g., textured by per-point intensity value) for the virtual world. A set of actor meshes may be curated that have complete and clean geometry, together with CAD assets to create an asset library to model actor shapes for benign actors in the scene. During simulation, the actor geometries is queried from the curated set based on the actor class and bounding box. The actor geometries are placed according to their respective pose ξₜ in the scenario snapshot at time t based on [symbol] ₜ. Ray casting may be performed based on the sensor configuration and SDV location to generate simulated LiDAR point clouds for the virtual driver system via \tilde{ψ}.

With a digital twin representation that reconstructs the 3D world, the example implementation can now model the scenario snapshot [symbol] ₜ. An actor is selected to modify the actor's shape. In the example of FIG. 5A, to ensure the actor shape affects the virtual driver performance, the closest actor (520) in front of the SDV (522) is selected as [symbol] ⁱ and the closest actor's shape [symbol] ⁱ is modified to be adversarial. To ensure the actor shape is realistic and is not a contrived and non-smooth mesh, the example implementation parameterizes the geometry [symbol] using a low-dimensional latent representation z (502) with realistic constraints. Specifically, for vehicle actors, the primary actor type in driving scenes, the example implementation learns a shape representation over a large set of CAD vehicle models (506) that represent a wide range of vehicles (e.g., city cars, sedans, vans, pick-up trucks). For each CAD vehicle shape, the example implementation first computes a volumetric truncated signed distance field (SDF) to obtain a dense representation. Then, the volumetric truncated SDF is flattened to obtained flattened volumetric SDFΦ∈ [symbol] ^{|L|×1} for each CAD vehicle shape.

Principal component analysis (PCA) may be performed over the flattened volumetric SDF of the whole CAD dataset to obtain the latent representation:

$$\\ \begin{matrix}z = {W}^{{}_{} ⊤} ( Φ - μ ) , 𝒢 ( z ) = MarchingCubes ( W \cdot z + μ ) , & ( 2 )\end{matrix}$$

where μ∈ [symbol] ^{|L|×1} is the mean volumetric SDF for the meshes and W is the top K principal components. The explicit mesh (504) is extracted using marching cubes. Note that each dimension in z (502) controls different properties of the actors (e.g., scale, width, height) in a controllable and realistic manner. To ensure during optimization the latent code z (502) is within the set of learned actor shapes and is realistic, the latent code is normalized to lie within the bounds of the minimum and maximum values of each latent dimension over the set of CAD models.

Adversarial 3D shape optimization may be performed as follows. With the simulation system \tilde{ψ}, black-box optimization, and the virtual driver system [symbol] under test, the example implementation can perform closed-loop simulation (508). Given the selected actor [symbol] ⁱ (520) and low-dimensional shape representation z, the next step is to optimize z (502) such that the overall the virtual driver performance drops significantly.

An adversarial objective (530) that accounts for the entire virtual driver system, aims to concurrently reduce the performance of each part of the virtual driver system. Taking an instance-based modular the virtual driver as an example, the adversarial objective [symbol] ₜ may combine the perception loss [symbol] _{det}, prediction loss [symbol] _{pred} and planning comfort cost cₚₗₐₙ to measure the overall virtual driver performance. One or more embodiments may increase perception errors by decreasing the confidence/Intersection of Union (IoU) for the true positive (TP) detections and increasing the confidence/IoU for false positive (FP) proposals. For motion forecasting, the example implementation computes the averaged displacement error (ADE) for multi-modal trajectory predictions. As the modified actor shape can also affect the perception and motion forecasting of other actors, the example implementation considers the average objective for the actors within the region of interest across the frames (e.g., timesteps of the simulation). In terms of planning, the example implementation calculates two costs that measures the comfort (jerk and lateral acceleration) of the driving plan at each snapshot time t. Additional costs may be calculated. The adversarial objective may be calculated as follows.

$$\\ \begin{matrix}{𝒞}_{t} = {ℓ}_{det}^{{}_{} t} + {λ}_{pred} {ℓ}_{pred}^{{}_{} t} + {λ}_{plan} {c}_{plan}^{{}_{} t} , & ( 3 )\end{matrix}$$

$$\\ \begin{matrix}{ℓ}_{det}^{{}_{} t} = - α {\sum }_{TP} IoU ( {B}^{{}_{} t} , \hat{B} {}^{{}_{} t} ) \cdot Conf ( \hat{B} {}^{{}_{} t} ) + β {\sum }_{FP} ( 1 - IoU ( {B}^{{}_{} t} , \hat{B} {}^{{}_{} t} ) ) \cdot Conf ( \hat{B} {}^{{}_{} t} ) , & ( 4 )\end{matrix}$$

$$\\ \begin{matrix}{ℓ}_{pred}^{{}_{} t} = \frac{1}{K} {\sum }_{i = 1}^{K} {\sum }_{h = 1}^{H} {‖ {g}_{j}^{{}_{} t , h} - {p}_{j}^{{}_{} t , h} ‖}_{2} , & ( 5 )\end{matrix}$$

$$\\ \begin{matrix}{c}_{plan}^{{}_{} t} = {c}_{jerk}^{{}_{} t} + {c}_{lat}^{{}_{} t} , & ( 6 )\end{matrix}$$

where B^{t}, \hat{B}^{t} are the ground truth and detected bounding boxes at time t and α, β are the coefficients to balance TP and FP objectives. gⱼ^{t,h}, pⱼ^{t,h} are the h-th ground truth and predicted waypoints for actor j at time t and H is the prediction horizon. Lastly, cⱼₑᵣₖ^{t} and cₗₐₜ^{t} represent the jerk (m/s³) and lateral acceleration (m/s²) cost at time t. The costs are aggregated over time Σₜ₌₁^{T} [symbol] ₜ to get the final closed-loop evaluation cost. Note that the approach is general and can find challenging actor shapes for any the virtual driver system in one or more embodiments.

The above adversarial objective (530) equations are instance-based joint detection and trajectory prediction. Specifically, the virtual driver system may identify various actors in the scene. For example, the virtual driver system may take voxelized LiDAR point clouds as input and outputs the birds-eye-view (BEV) bounding box parameters for each actor detected. For the trajectory prediction part, the virtual driver may take lane graph and detection results as input and outputs the per-timestep endpoint prediction for each actor.

In another implementation, the virtual driver system performs instance-free autonomy for joint detection and motion forecasting. The instance-free virtual driver system performs non-parametric binary occupancy prediction as perception results and flow prediction as motion forecasting results for each query point on a query point set. The occupancy and flow prediction can serve as the input for the sampling-based planner to perform motion planning afterwards.

For the instance free virtual driver system, the following equations for detection loss [symbol] _{det}^{t} and prediction loss [symbol] _{pred}^{t} may be used instead of the corresponding equations (4) and (5) above.

$$\\ \begin{matrix}{ℓ}_{det}^{{}_{} t} = - \frac{{\sum }_{q ϵ Q} o ( q ) \hat{o} ( q )}{{\sum }_{q ϵ Q} ( o ( q ) + \hat{o} ( q ) - o ( q ) \hat{o} ( q ) )} , & ( 7 )\end{matrix}$$

$$\\ \begin{matrix}{ℓ}_{pred}^{{}_{} t} = \frac{1}{{\sum }_{q ϵ Q} o ( q )} {\sum }_{q ϵ Q} o ( q ) {‖ f ( q ) - \hat{f} ( q ) ‖}_{2} , & ( 8 )\end{matrix}$$

where Q is the query point set o(q) and ô(q) are ground truth and predicted binary occupancy value, respectively, in the set of [0,1] on query point q. Flow vector ƒ: [symbol] ³→ [symbol] ² and the corresponding prediction \hat{ƒ} specify the BEV of an agent that occupies that location.

Continuing with FIG. 5A, black-box optimization (540) may be applied so that the process may be applied to various virtual driver systems (including non-differentiable modular virtual driver systems). For example, Bayesian Optimization (BO) may be used as the search algorithm with Upper Confidence Bound (UCB) as the acquisition function. Since the adversarial landscape is not locally smooth, the example implementation may use standard Gaussian process with a Matérn kernel. Other search algorithms may be used including grid search (GS), random search (RS) and blend search (BS). As another, example, brute-force search (BF) may be performed.

FIG. 5B shows an example (550) of a digital twin (552) and a mixed reality version (560). The digital twin (552) has the original actor shape in the real world. An exploded view (554) of the original actor shape is also shown. The mixed reality version (560) has the original actor shape modified as shown in the exploded view (562) according to the technique shown in FIG. 5A. As shown, the modification produces a realistic change in the actor to reflect possible future vehicles or how individuals may modify their vehicles in the real world. By being able to modify the appearance in a realistic manner, one or more embodiments are able to fully test the virtual driver system.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 6A, the computing system (600) may include one or more computer processors (602), non-persistent storage (604), persistent storage (606), a communication interface (612) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) may be one or more cores or micro-cores of a processor. The computer processor(s) (602) includes one or more processors. The one or more processors may include a central processing unit (CPU), a graphics processing unit (GPU), a tensor processing unit (TPU), combinations thereof, etc.

The input devices (610) may include a touchscreen, keyboard, mouse, microphone, touchpad, electronic pen, or any other type of input device. The input devices (610) may receive inputs from a user that are responsive to data and messages presented by the output devices (608). The inputs may include text input, audio input, video input, etc., which may be processed and transmitted by the computing system (600) in accordance with the disclosure. The communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

Further, the output devices (608) may include a display device, a printer, external storage, or any other output device. One or more of the output devices may be the same or different from the input device(s). The input and output device(s) may be locally or remotely connected to the computer processor(s) (602). Many different types of computing systems (600) exist, and the aforementioned input (610) and output device(s) (608) may take other forms. The output devices (608) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (600) in FIG. 6A may be connected to or be a part of a network. For example, as shown in FIG. 6B, the network (620) may include multiple nodes (e.g., node X (622), node Y (624)). Each node may correspond to a computing system, such as the computing system (600) shown in FIG. 6A, or a group of nodes combined may correspond to the computing system (600) shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system (600). Further, one or more elements of the aforementioned computing system (600) may be located at a remote location and connected to the other elements over a network.

The nodes (e.g., node X (622), node Y (624)) in the network (620) may be configured to provide services for a client device (626), including receiving requests and transmitting responses to the client device (626). For example, the nodes may be part of a cloud computing system. The client device (626) may be a computing system, such as the computing system shown in FIG. 6A. Further, the client device (626) may include and/or perform all or a portion of one or more embodiments.

The computing system of FIG. 6A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A computer-implemented method comprising:
obtaining a first latent representation of an actor;
generating a first three-dimensional (3D) model from the first latent representation;
performing, by a simulator interacting with a virtual driver of an autonomous system, a first simulation of a virtual world having the first 3D model of the actor and the autonomous system moving in the virtual world;
evaluating, using an adversarial objective function, the virtual driver interacting in the virtual world during the first simulation to obtain a first evaluation result;
performing a modification, according to the first evaluation result, of the first latent representation of the actor to obtain a second latent representation;
generating a second 3D model from the second latent representation;
performing, by the simulator interacting with the virtual driver, a second simulation of the virtual world having the second 3D model of the actor and the autonomous system moving in the virtual world;
evaluating the virtual driver interacting in the virtual world during the second simulation to obtain a second evaluation result; and
outputting the second evaluation result.

2. The computer-implemented method of claim 1, further comprising:
obtaining a real-world model of the actor;
transforming the real-world model into a third latent representation; and
modifying the third latent representation to generate the first latent representation.

3. The computer-implemented method of claim 1, further comprising:
computing a volumetric truncated signed distance field (SDF) of a plurality of real-world models to obtain a plurality of dense representations, the plurality of real-world models comprising a real-world model of the actor, and the plurality of dense representations comprising a dense representation of the real-world model;
performing principal component analysis on the plurality of dense representations to obtain a set of principal components and a mean of the plurality of dense representations; and
applying the set of principal components and the mean to the dense representation as at least part of obtaining the first latent representation.

4. The computer-implemented method of claim 3, further comprising:
applying the set of principal components and the mean to the plurality of dense representations to obtain a plurality of latent representations;
determining a plurality of constraint values from the plurality of latent representations; and
constraining the modification of the first latent representation according to the plurality of constraint values when obtaining the second latent representation.

5. The computer-implemented method of claim 1, wherein generating the second 3D model comprises:
generating a plurality of marching cubes from the second latent representation.

6. The computer-implemented method of claim 1, wherein the first simulation and the second simulation are closed-loop simulations.

7. The computer-implemented method of claim 1, wherein the adversarial objective function calculates a cost that is a sum of a set of losses, and wherein the method further comprises:
performing, through iteratively modifying latent representations of the actor, simulating the virtual world with the actor, and evaluating, a search algorithm on the cost to identify a set of actor shapes that the virtual driver incorrectly processes.

8. The computer-implemented method of claim 1, further comprising:
receiving, during the first simulation, a detected bounding box detected by the virtual driver for the actor,
wherein evaluating the virtual driver using the adversarial objective function comprises comparing the detected bounding box to an actual bounding box during the first simulation to generate a detection loss in the first evaluation result, and
wherein the detection loss is increased when the detected bounding box matches the actual bounding box.

9. The computer-implemented method of claim 1, further comprising:
receiving, during the first simulation, a false detected bounding box detected by the virtual driver for a hallucinated actor,
wherein evaluating the virtual driver using the adversarial objective function comprises decreasing a detection loss in the first evaluation result based on the false detected bounding box.

10. The computer-implemented method of claim 1, further comprising:
receiving, during the first simulation, a predicted trajectory of the actor by the virtual driver,
wherein evaluating the virtual driver using the adversarial objective function comprises comparing the predicted trajectory to an actual trajectory during the simulation to generate a prediction loss, and
wherein the prediction loss is increased when the predicted trajectory matches the actual trajectory.

11. The computer-implemented method of claim 1, further comprising:
increasing a planning loss based on an amount of jerk and lateral acceleration caused by the virtual driver during the first simulation.

12. The computer-implemented method of claim 1, further comprising:
receiving a predicted occupancy of a plurality of voxels detected by the virtual driver during timesteps of the first simulation,
wherein evaluating the virtual driver using the adversarial objective function comprises comparing the predicted occupancy with an actual occupancy of the plurality of voxels, and
wherein the first evaluation result comprises a detection loss that is increased when the predicted occupancy matches the actual occupancy and decreased when the predicted occupancy does not match the actual occupancy.

13. The computer-implemented method of claim 1, further comprising:
receiving a predicted trajectory of a plurality of voxels detected by the virtual driver during timesteps of the first simulation,
wherein evaluating the virtual driver using the adversarial objective function comprises comparing the predicted trajectory with an actual trajectory of the plurality of voxels, and
wherein the first evaluation result comprises a detection loss that is increased when the predicted trajectory matches the actual trajectory and decreased when the predicted trajectory does not match the actual trajectory.

14. A system comprising:
memory; and
a computer processor comprising computer readable program code for performing operations comprising:
obtaining a first latent representation of an actor,
generating a first three-dimensional (3D) model from the first latent representation,
performing, by a simulator interacting with a virtual driver of an autonomous system, a first simulation of a virtual world having the first 3D model of the actor and the autonomous system moving in the virtual world,
evaluating, using an adversarial objective function, the virtual driver interacting in the virtual world during the first simulation to obtain a first evaluation result,
performing a modification, according to the first evaluation result, the first latent representation of the actor to obtain a second latent representation,
generating a second 3D model from the second latent representation,
performing, by the simulator interacting with the virtual driver, a second simulation of the virtual world having the second 3D model of the actor and the autonomous system moving in the virtual world,
evaluating the virtual driver interacting in the virtual world during the second simulation to obtain a second evaluation result, and
outputting the second evaluation result.

15. The system of claim 14, wherein the operations further comprise:
obtaining a real-world model of the actor;
transforming the real-world model into a third latent representation; and
modifying the third latent representation to generate the first latent representation.

16. The system of claim 14, wherein the operations further comprise:
computing a volumetric truncated signed distance field (SDF) of a plurality of real-world models to obtain a plurality of dense representations, the plurality of real-world models comprising a real-world model of the actor, and the plurality of dense representations comprising a dense representation of the real-world model;
performing principal component analysis on the plurality of dense representations to obtain a set of principal components and a mean of the plurality of dense representations; and
applying the set of principal components and the mean to the dense representation as at least part of obtaining the first latent representation.

17. The system of claim 16, wherein the operations further comprise:
applying the set of principal components and the mean to the plurality of dense representations to obtain a plurality of latent representations;
determining a plurality of constraint values from the plurality of latent representations; and
constraining the modification of the first latent representation according to the plurality of constraint values when obtaining the second latent representation.

18. A non-transitory computer readable medium comprising computer readable program code for performing operations comprising:
obtaining a first latent representation of an actor;
generating a first three-dimensional (3D) model from the first latent representation;
performing, by a simulator interacting with a virtual driver of an autonomous system, a first simulation of a virtual world having the first 3D model of the actor and the autonomous system moving in the virtual world;
evaluating, using an adversarial objective function, the virtual driver interacting in the virtual world during the first simulation to obtain a first evaluation result;
performing a modification, according to the first evaluation result, the first latent representation of the actor to obtain a second latent representation;
generating a second 3D model from the second latent representation;
performing, by the simulator interacting with the virtual driver, a second simulation of the virtual world having the second 3D model of the actor and the autonomous system moving in the virtual world;
evaluating the virtual driver interacting in the virtual world during the second simulation to obtain a second evaluation result; and
outputting the second evaluation result.

19. The non-transitory computer readable medium of claim 18, wherein the operations further comprise:
computing a volumetric truncated signed distance field (SDF) of a plurality of real-world models to obtain a plurality of dense representations, the plurality of real-world models comprising a real-world model of the actor, and the plurality of dense representations comprising a dense representation of the real-world model;
performing principal component analysis on the plurality of dense representations to obtain a set of principal components and a mean of the plurality of dense representations; and
applying the set of principal components and the mean to the dense representation as at least part of obtaining the first latent representation.

20. The non-transitory computer readable medium of claim 19, wherein the operations further comprise:
applying the set of principal components and the mean to the plurality of dense representations to obtain a plurality of latent representations;
determining a plurality of constraint values from the plurality of latent representations; and
constraining the modification of the first latent representation according to the plurality of constraint values when obtaining the second latent representation.
